(19) United States
(12) Patent Application Publication
(10) Pub. No.: US 2003/0189011 A1
(43) Pub. Date: Oct. 9, 2003

(54) Process and method for recovery of halogens

(76) Inventors: Douglas MacFarlane, Clayton (AU); Peter Newman, Clayton (AU)

Correspondence Address: BIRCH STEWART KOLASCH & BIRCH, PO BOX 747, FALLS CHURCH, VA, 22040-0747, US

(21) Appl. No.: 10/333,464

(22) PCT Filed: Jul. 21, 2001
(86) PCT No.: PCT/AU01/00892

(30) Foreign Application Priority Data
Jul. 21, 2000 (AU) PQ 8915

(51) Int. Cl. B03C 1/00

(52) U.S. Cl. 210/748

(57) ABSTRACT

An apparatus for the recovery of a halogen or pseudohalogens from a halide compound in solution; wherein the apparatus includes;

an electrochemical cell including, an electrode assembly including at least a first and second electrodes in communication with a controller for providing a current to at least two of said electrodes;

wherein, upon delivery of a current sufficient to generate a predetermined voltage measured between one of the said electrodes and a reference electrode placed in said solution in close proximity to the said electrode said halide compound is oxidised at one or more said electrodes to form a halogen corresponding to said halide in solution whereupon said halogen is deposited on said one or more electrode upon completion of oxidation.

### BACKGROUND

The present invention relates to a process and method for recovery of halogens such as but not limited to iodine and bromine from solutions containing the corresponding halide such as iodide or bromide. The invention further relates to an electrowinning process and method for the recovery of heavy halogens and pseudohalogens and more particularly relates to a method involving the oxidation of a halide at an electrode and collection of a corresponding halogen solution or as a solid precipitate. The invention further relates to the production, by the recovery process and method, of a high surface area fast dissolving iodine specie for use in such non limiting applications as water purification, food sanitization using water and water reticulation networks.

Prior Art

Halogens are used in a variety of industry applications including the disinfection of water used in food washing processes and in water consuming appliances or infrastructure where it is necessary to achieve an acceptable level of biocidal action in and sanitization of the water. A typical example of this is the use of iodine as an agent for microbiological control in water supplies. An example of a method for disinfecting water using iodine species is disclosed in U.S. Pat. No. 5,919,374 to Harvey. The method described therein involves dissolving solid iodine into a first water flow to produce a saturated iodine species-containing aqueous solution at a predetermined temperature; blending the saturated solution with a second water flow to produce a diluted iodine species bacterium free solution and providing the diluted solution as drinking water. That patent also teaches the use of iodinated water as a disinfectant, for example in the food processing industry; fruit, vegetable and fish preservation; industrial commercial cooling tower waters, sewage and waste water treatment.

Iodine has advantages as a purification and disinfecting agent and a number of systems such as the above example, have been developed which employ molecular iodine in the sanitization of water for drinking purposes and in processes which include disinfection of sewage. In such processes using iodinated water, it is important to maintain an optimal level of iodine to ensure that the appropriate level of disinfection is achieved. Iodine is used up in disinfection processes necessitating periodic replenishment of the required concentration.

Iodine dosing systems have been used for the recharging of water supply with an acceptable minimum amount of active iodine. In those processes the recharging is effected by treatment with an aqueous iodine solution produced by flowing water through a bed of iodine crystals. The iodine residual is monitored for example by use of iodine sensitive electrodes and the bed recharged where necessary by adjusting the flow rate of water through the bed of iodine crystals.

The known processes which use iodine disinfection do not teach an economic method for recovery of iodine, iodine species or iodide for reuse. Since iodine is a valuable material this limits the type of disinfection application in which iodine has previously been used.

The product of the process for the production of iodine according to one embodiment of the invention to be described herein is a molecular iodine in a morphological form that is different from those produced by prior art methods. The advantages of the iodine product over the prior art are particularly manifest when the iodine species is dissolved in water in a flowing system. The iodine produced by prior art methods are inefficient in their application. For example, the iodine dissolves slowly in a water stream and is therefore only useful at slow flow rates.

Iodine is recovered from mineral salt solutions in a variety of ways that have been described in U.S. Pat. Nos. 4,036,940, 4,976,947, 5,356,611, 5,464,603, 4,131,645, 6,004,465 and 4,650,649.

These disclosures all describe methods of producing iodine in large quantities from iodide using a variety of chemical oxidants and isolation methods. These methods are useful on a large scale but are more difficult to apply or are uneconomic on a small scale. The increasing use of iodine in a variety of disinfection and specialized chemical extraction processes has produced the need for methods of regenerating iodine from iodide solutions on a smaller scale either in a batch process or in a continuous flowing system. In either case the large scale oxidation and separation processes are difficult and expensive to apply.

A further problem with these existing methods of iodine generation is the retention of residual contaminants in the iodine as a result of the method of preparation. For example oxidation of iodide with chlorine (Cl₂) is effective but leaves traces of chloro compounds in the materials obtained. In some cases sublimation or other purification steps are needed subsequently to remove these contaminants. This issue is particularly acute in applications of the iodine in medical and food contact areas where the presence of chloro compounds may be highly undesirable. One of the purposes of the present invention is to provide a means by which iodine can be produced free of such impurities without the need for further purification.

The oxidation of iodide to iodine by electrochemical methods is a well known chemical reaction. However the reaction has not previously been developed into a viable production process for iodine.

Electrowinning as a process and devices for this purpose are also well known in the prior art as a means of producing valuable metals from solutions of the metal ions Examples include copper production, gold production and aluminium production. Each of these represents an electrochemical reduction process applied to the substance of interest. Examples of electrochemical oxidation processes as applied to bulk conversion of materials include the oxidation of chloride ions in solutions such as swimming pool water to chlorine. In each case the chemistry of the process, cell design and materials are different but the principle is well established. Each of these processes requires an electrowinning cell or device which;

(i) allows appropriate handling and in some cases isolation of the active materials and solutions,

(ii) provides electrode materials which are able to support the reaction at minimal overpotential and which are not themselves undesirably consumed by the process or by other side reactions,

(iii) provides a means to collect the product material.

One of the side reactions that is of importance in the electrowinning of iodine is the formation of the triiodide ion. This species is formed as an inevitable part of the oxidation of iodide:

3I⁻—→I₃⁻+2e⁻

This complete formation of triiodide from iodide represents 66% completion of the overall oxidation from iodide to iodine. Only by driving the process beyond this 66% point is iodine produced. However if this triiodide species is allowed to reach the counter-electrode as in many prior art processes and cell designs, then it is readily re-reduced to iodide thus forming an unproductive cycle in which electricity is consumed for no useful outcome other than heat.

Invention

The present invention provides a process and method for the production of iodine from iodide in solution, wherein the iodine produced has a morphology which allows it to dissolve at a rate faster than the known iodine species and which is suitable for use in high flow sanitising processes. The invention further provides an electrodeposited iodine which is produced from said process and method and which may be recovered from an electrode in a morphological form which enables the iodine to readily dissolve in fast flow streams.

It is one object of the present invention to provide an apparatus which enables electrowinning to be carried out on iodide solutions for the production of iodine in either batch processes or flow through processes.

In one broad form, the present invention provides an alternative method and process for the recovery of a halogen from a halide solution using electrochemical means; wherein the process is adapted for small scale halogen recovery operations. According to one embodiment, a halogen solution is passed through an electrowinning cell characterised in that the cell is arranged to avoid the re-reduction of the desired product at a cathode or counter electrode.

The invention further provides according to one embodiment, molecular electro deposited iodine in a morphological form that dissolves faster in water than those iodine specie produced by prior art methods. The advantages of the iodine product over the prior art are particularly manifest when the iodine species is dissolved in water in a flowing system.

The production of the heavy halogens from mineral sources is an important industrial process. The invention also provides a means for the production and recycling of heavy halogens in closed processes such as those that use halogens in the recovery of gold and also the use of halogens in sanitizing food, water reticulation systems and air conditioning systems.

According to a method aspect, a halogen such as iodine may be recovered from solution by passing the solution through an electrowinning cell which operates to avoid the re-reduction of a halogen at a counter electrode. According to a preferred embodiment, the process and method employs a current and voltage control regime which maximizes electrochemical efficiency and avoids the formation of by products. According to one embodiment, the method and process provides an iodine species from the electrowinning process namely iodine, being in a morphological form that is rapidly soluble and therefore is particularly useful in flow through dosing systems.

More particularly according to one embodiment, the invention provides a method of oxidising solutions of iodide, bromide and other halogen compounds to produce the corresponding halogen such as iodine and bromine for recovery, and where applicable, reuse in a sanitising system.

In co pending Australian provisional patent application PQQ8916, the present applicant describes an improved method and process for controlled delivery of iodine for disinfection and the recovery of iodide for conversion to iodine and replenishment of iodine in an iodine sanitising method and process. In one broad form, the present invention provides a supplementary process and method for the recovery of iodide and production of an improved iodine specie and which may be adapted for use in line with or remote from an iodine purification process such as that described in co pending application PQ8916. Also, the iodine species produced by the process and method of the present invention further enhances the operation of the process and method of PQ8916.

In one broad form of the apparatus aspect the present invention comprises;

an apparatus for the recovery of a halogen from a halide compound in solution; wherein the apparatus includes;

an electrochemical cell including an electrode assembly including at least a first and second electrode in communication with a controller for providing a current to at least one said electrodes;

wherein, upon delivery of a predetermined voltage, said halide compound is oxidised at one or more said electrodes to form a halogen corresponding to said halide in solution whereupon said halogen is deposited on at least one said electrode in a morphological form which enables the halogen to dissolve rapidly in solution.

Preferably, the predetermined voltage is a function of the concentration of said halide compound such as iodide and the pH. The voltage is also dependent on the electrode material used. To determine the optimum voltage, the solution to be supplied to the cell is subjected to a cyclic voltammetry analysis. Preferably this analysis is carried out in the electrowinning cell itself under exactly identical conditions to the electrowinning process itself. The method of cyclic voltammetry is well known to those skilled in the art of electrochemisty and involves scanning the voltage on the electrode and measuring the current. The voltage referred to here is that electric potential, hereinafter simply referred to as potential, measured between the reference electrode and the working electrode. It is possible also to perform the cyclic voltammetry measurement on a cell which contains only working and counter electrodes. The cyclic voltammogram typically will show a wave corresponding to the onset of the iodide oxidation. The set potential is chosen from this wave as being the lowest potential at which the current is at or near its maximum value.

There are other equivalent methods by which this analysis can be carried out that are well known to those skilled in the art of electrochemistry including linear sweep voltammetry, and staircase voltammetry.

The electrode assembly preferably comprises a working electrode or anode, a reference electrode and a cathode or counter electrode.

The choice of electrode material is critical to the process. Platinum, platinum alloys and platinum plated materials may be used. However the cost of platinum tends to be prohibitive. Silver and gold tend to form iodide compounds in iodide solutions and therefore are not generally useful. Stainless steel in its various grades is preferred. Stainless steel is slowly corroded at higher potentials and acid concentrations, however the rate of this process is of only minor significance in the electrowinning process and economics. Carbon and graphite in their various forms are alternative choices although there is a tendency for compound formation which consumes the electrode and limits the electrowinning process. Nickel, titanium and zirconium, especially as their alloys, are alternative choices. The preferred material on balance of economic and practical factors is stainless steel.

The cathode is preferably stainless steel and the reference electrode may be one of the standard reference electrodes well known to those skilled in the art of electrochemistry. Preferably the reference electrode is Ag/Ag+.

Preferably, the anode and reference electrodes are immersed in a solution comprising the halide solution which has been mixed with a predetermined concentration of an acid such that the pH of the mixture is less than 4 and preferably less than 3. The acid concentration is preferably the same or greater than that of the oxidisable halide content of the solution. The acid is one of nitric, sulphuric, acetic, citric or other common acid or mixture of these. Preferably the acid is H₂SO₄. The counter electrode is immersed in a bath of a predetermined concentration of acid, preferably H₂SO₄.

The halogen is preferably deposited on said anode.

According to one embodiment of the invention, the halide is iodide and the halogen is iodine, wherein the electric potential required for the production of iodine will fall within the range ca +0.4 to 0.5 volts for iodide on a platinum electrode and between 1.4 and 1.6 V on a stainless steel electrode. The electric potential is measured between the working electrode and the reference electrode.

In another broad form the present invention comprises; an apparatus for the recovery of a halogen from its corresponding halide in solution wherein the apparatus includes,

at least one electrode which receives a voltage at a level predetermined according to a concentration of said halide in solution;

a controller for controlling the voltage delivered to said at least one electrode; and means for collecting said halogen precipitated from said solution on said electrode.

Preferably, the predetermined voltage is also determined with reference to the electrode material.

In a broad form of the method aspect the present invention comprises;

a method of recovery of a halogen by oxidation of a solution of a corresponding halide compound, the method comprising the steps of:

a) taking an electroreactor and placing the reactor in or near a stream of liquid having a halide in solution;

b) providing in said reactor a first electrode in communication with a controller;

c) providing second and third electrodes in communication with said controller;

d) passing a predetermined voltage through said electrodes to oxidise said halide in solution.

e) providing means for collecting a halogen corresponding to said halide precipitated at said third electrode and corresponding to said halide in solution.

Preferably, the method comprises the further step of controlling a voltage to said electrodes according to the level of concentration of a halide compound in solution and the pH of the solution; wherein said controlled potential close to the oxidation potential for the predetermined halide is maintained. Preferably the first electrode comprises a cathode, said second electrode comprises a reference electrode and said third electrode comprises an anode

The method preferably comprises the further step of allowing oxidation of the halogen to take place at a controlled potential close to the oxidation potential for the predetermined halide.

In another broad form the present invention comprises;

an iodine specie produced by an apparatus for the recovery of a halogen from a halide compound in solution; wherein the apparatus includes;

an electrode assembly including at least first and second electrodes in communication with a controller for providing a predetermined voltage to at least one said electrodes;

wherein, upon delivery of said predetermined voltage, said halide compound is oxidised at one or more said electrodes to form a halogen corresponding to said halide in solution whereupon said halogen is collected from said one or more electrode upon completion of oxidation; wherein said iodine specie has a bulk density less than 2.25 g/cm3.

The bulk density of the iodine specie may fall within the range of 1.0 g/cm3-2.0 g/cm3. Preferably, the bulk density lies in the range 1.35-1.65 g/cm3 wherein a bulk density value is determined by a selected method of electrowinning. The bulk density is a function of the manner of formation of said iodine specie on the anode employed in said electrowinning method.

The iodine is deposited on said electrode in a molecular or particulate morphological form having high surface area relative to known iodine species; wherein the particulate form of deposit on the electrode with high surface area accelerates dissolving of the iodine when introduced into a solution. The particulate morphology of the iodine deposited on the electrode is a function of the selected electrode material, current density, voltage level and a supporting electrolyte employed in said electrowinning process.

Preferably, the particulate deposit on the electrode has an appearance of an aggregate of primary spherical particles. The iodine is fast dissolving by comparison to known iodine species and in fact dissolves 3-4 times faster than known iodine species such as prilled or sublimed iodine.

The form in which iodine is produced as a result of the application of the process and method of the invention has particular advantages when the iodine dissolves in water in a flowing system. The iodine which may be produced by one application of the process of the present invention is described herein as Electro-deposited Iodine, abbreviated to EDI.

According to one embodiment, a halide is present in a tank reactor or flowing stream of solution. The halide solution is oxidised by electrochemical means in an apparatus including an electrowinning cell.

The Halide solution entering the recovery process may be present in concentrations between 1 ppm and up to a solubility limit of the salt involved (up to 50 wt %). Preferably the solvent is water but it will be appreciated by those skilled in the art that other solvents and ionic liquids may be used or indeed any solvent in which the halide is soluble.

Oxidation of the halogen takes place at a controlled potential close to the oxidation potential for the predetermined halide on the working electrode in use. For example an oxidation potential for iodine may be within the range ca +0.4 to 0.5 volts for iodide on platinum or may be in the range of 1.4-1.6 V on stainless steel. It is important that the potential not be allowed to exceed the oxidation potential because other side reactions can then take place. An example is oxidation of iodide to the iodate ion.

According to a preferred embodiment, the method comprises the further step of controlling a current flow to said third electrode according to the level of concentration of halide in solution.

Preferably a controlled potential close to the oxidation potential for the predetermined halide is maintained.

According to a preferred embodiment, said first electrode comprises a cathode, said second electrode comprises a reference electrode and said third electrode comprises an anode. Preferably the method comprises the further step of including an optical sensor.

It is a further object of the present invention to provide a novel form of iodine which has very high surface area and which thereby exhibits rapid solubility in water. The particulates are characterized as being of sizes within the range 1 nm-10 micrometers. The sample typically contains a range of particle sizes. Typically the majority of particles are in the range 100 nm-1 micro meter.

In its broadest form the present invention comprises:

an apparatus for the recovery of a heavy halogen or pseudohalogens from a halide compound in solution; wherein the apparatus includes;

an electrochemical cell including, an electrode assembly including at least a first and second electrodes in communication with a controller for providing a current to at least two of said electrodes;

wherein, upon delivery of a current sufficient to generate a predetermined voltage measured between one of the said first and second electrodes and a reference electrode placed in said solution in close proximity to the said first electrode, said halide compound is oxidised at one or more said electrodes to form a halogen corresponding to said halide in solution whereupon said halogen is deposited on said one or more electrode; wherein gradual production of the halogen takes place at a controlled voltage close to the oxidation potential for the halide solution on an anode.

In another broad form of a method aspect the present invention comprises:

a method of recovery of a heavy halogen or pseudohalogen by oxidation of a solution having a corresponding halide compound, the method comprising the steps of:

a) taking an electroreactor and placing the reactor in a tank or moving stream of liquid;

b) providing in said reactor a first electrode in communication with a controller;

c) providing at least a second electrode in communication with said controller;

d) applying a current between said electrodes sufficient to generate a predetermined voltage measured between one of said first and second electrodes and a reference electrode placed in said solution in close proximity to the said first electrode, sufficient to oxidize said halide in solution

e) providing means for collecting said halogen corresponding to said halide and precipitated at one said electrode.

In another broad form the present invention comprises:

an iodine specie produced by an apparatus for the recovery of a halogen from a halide compound in solution; wherein the apparatus includes;

an electrode assembly including at least a first and second electrodes being an anode and a cathode respectively in communication with a controller for providing a current to said electrodes

wherein, upon delivery of a current to said electrodes sufficient to generate a predetermined voltage measured between the anode and a reference electrode placed in said solution in close proximity to the anode, said halide compound is oxidised at the anode to form a halogen corresponding to said halide in solution; whereupon said halogen is deposited in a morphological form having high surface area.

In another broad form the present invention comprises:

an iodine specie produced by an apparatus for the recovery of a halogen from a halide compound in solution; wherein the apparatus includes;

an electrode assembly including at least a first and second electrodes in communication with a controller for providing a current to at least one said electrodes;

wherein, upon delivery of a current between said electrodes sufficient to generate a predetermined voltage measured between one of the said electrodes and a reference electrode placed in said solution in close proximity to said first electrode, said halide compound is oxidised at one or more said electrodes to form a halogen corresponding to said halide in solution; whereupon said halogen is deposited in a morphological form having high surface area.

### DETAILED DESCRIPTION

The present invention will now be described in more detail according to preferred but non limiting embodiments and with reference to the accompanying illustrations wherein:

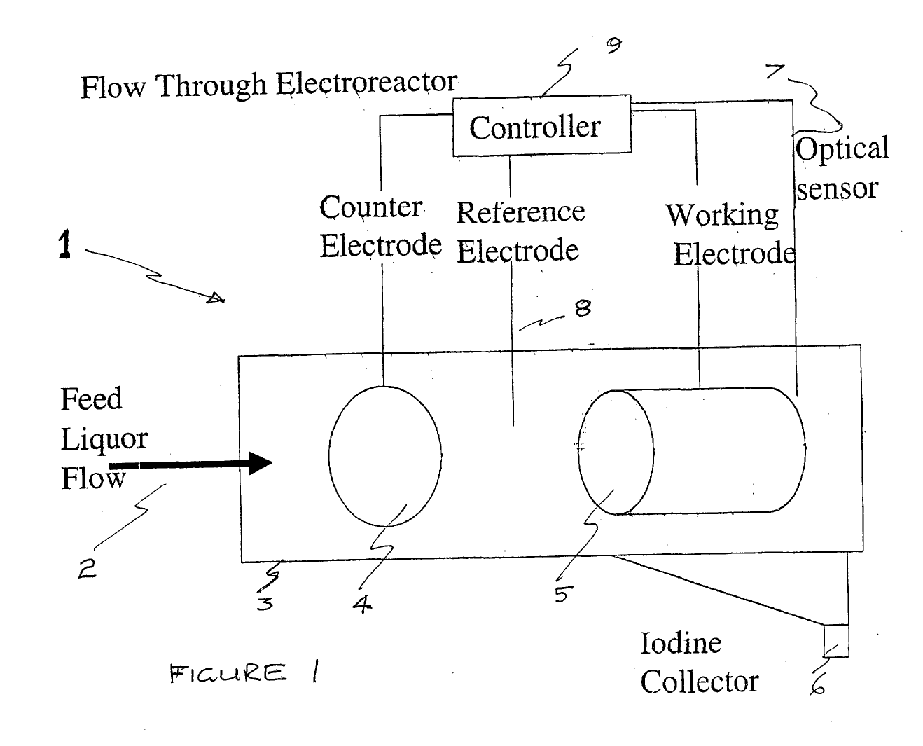

FIG. 1 shows a preferred embodiment of a flow through apparatus for recovery of a halogen from its corresponding halide in a flowing solution;

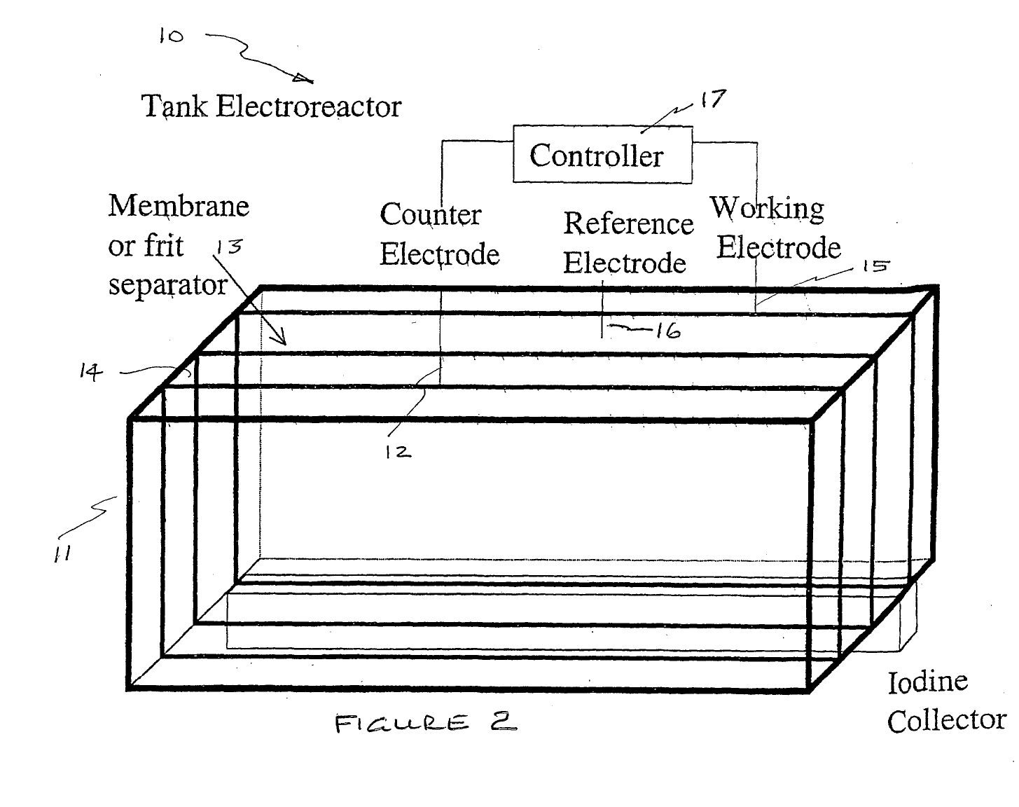

FIG. 2 shows a preferred embodiment of a tank electroreactor for the recovery of a halogen from its corresponding halide.

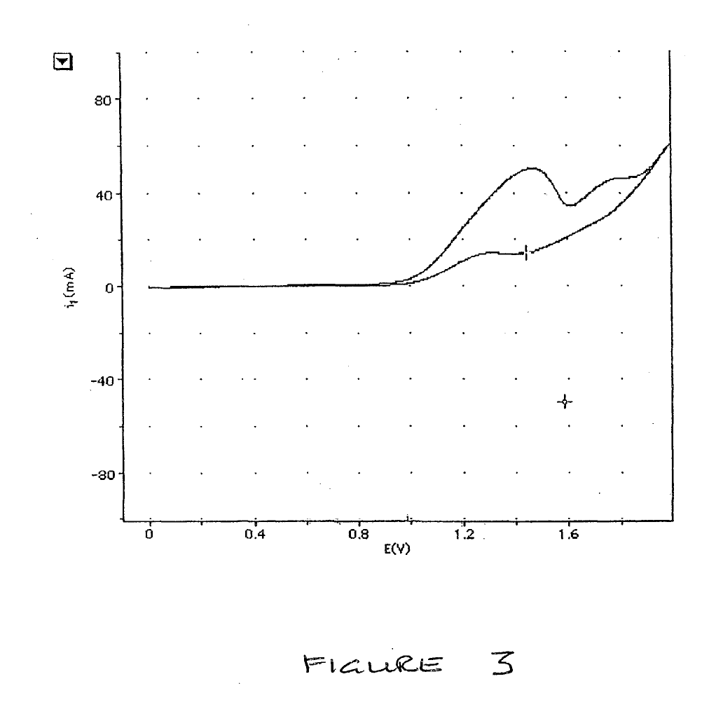

FIG. 3 shows a sample cyclic voltammogram.

Referring to FIG. 1 there is shown an arrangement including a flow through electroreactor 1 for the recovery of a halogen such as iodine from a flow stream 2. The arrangement will be described with reference to the recovery of iodine but it will be appreciated by persons skilled in the art that the process may be adapted to recovery of other halogens.

Flow stream 2 will include a halide in solution up to the solubility limit of the particular salt and preferably up to 50 wt %. Flow stream 2 will most commonly be a solution in water but may be other solvents and ionic liquids in which the halide is soluble. Flow stream 2 enters a typically pipe shaped cell 3 which includes a counter electrode or cathode 4 located upstream of a main or anode or working electrode 5. Electrode 5 receives sufficient current to achieve full oxidation of all iodide present to iodine as the solution passes across the main electrode. The following formula represents the relationship between required current level and the concentration of halide in flow stream 2.

I=nvCF

where

I=Current

n=the number of moles of electrons required to fully oxidize one mole of oxidisable species,

v is the flow rate in cm 3/s;

C=the oxidisable species concentration in mol per cm3; and.

F=Farady's constant

Preferably, working electrode 5 may comprise a plate or tube arrangement or may be constructed from materials such as a metal wool, metal coils or other high surface area conductive material including carbon and graphite. In the example described, the iodine will precipitate downstream of electrode 5 whereupon it will be collected by a collector valve 6. Preferably, the apparatus further includes a sensor 7 such as an optical sensor which monitors the colour of flow stream 2 immediately downstream of the electrode. Typically the apparatus includes a controller in communication with counter electrode 4, working electrode 5 and reference electrode 8. The controller is typically a potentiostat commonly used in the electrochemical field. A reading from the sensor is fed to the potentiostat and a flow rate control loop such that a voltage and flow rate appropriate to produce a sparingly low degree of coloration is achieved. In larger installations, controller 9 may be replaced with a simple current generator wherein the amount of current is set manually or by computer control in order to produce the required potential at electrode 5 as measured between electrode 5 and reference electrode 8. In electroreactor 1 it can be an advantage to include optical sensor 7 in line such that the concentration of the iodine or other halogen in the flowing solution can be monitored by colourimetry and fed by computer control into the electrical control sequence such that the amount of current is adjusted to produce an optimum degree of oxidation. Reference electrode 8 allows a reliable measurement of the potential of anode 5 irrespective of the current flowing in the electroreactor 1. The potential of the working electrode 5 is held by the potentiostat at the potential required to oxidize the halide (such as iodide), but not so high as to allow other parasitic processes to take place. In the case of bromine electrowinning, the product bromine is soluble to useful levels in aqueous solutions and in some closed loop processes it may be suitable to allow the bromine to remain in solution as it passes out of the flow through cell and returns to the process. The same is true of iodine in closed loop processes. In this case, the insolubility of iodine can be overcome by restricting the oxidation to the formation of the triiodide species by limiting the amount of current applied to 66% of its full oxidation value. The triiodide thus formed can be routed back into the process where it can act as an oxidant of efficacy similar to that of iodine.

Referring to FIG. 2 there is shown a schematic representation of an electroreactor 10 including a tank 11 which receives a predetermined quantity of halide in solution. Electroreactor 10 further includes a counter electrode 12 which is isolated from the solution by membrane or frit separator 13. The membrane may be Nafion (trade name) or glass frit. Counter electrode 12 is housed in chamber 14 which is filled with an acidic solution such as sulphuric acid. The acid will become less acidic during the process and may need to be replaced periodically. The halogen to be collected will form around the main (working) electrode 15 and in the case of iodine will generally precipitate to the bottom of tank 11 where it can be collected. Rotation of the working electrode 15 with a scraping device can be employed to assure that mass transport of the electrode is not a limiting factor and that product does not build up in the electrode. The apparatus of FIG. 2 further comprises reference electrode 16 and controller 17 which function as described for he apparatus of FIG. 1.

According to a preferred embodiment the halide solution may be present in concentrations between 1 ppm and up to the solubility limit of the salt involved which would be around 50 wt %. According to the method aspect the halogen is produced by oxidation at a controlled potential close to the predetermined oxidation potential for the halide on the electrode being used (eg ca +0.4 to 0.5V for iodide on platinum). It is important that the potential not be allowed to exceed this predetermined potential since other side reactions can then take place for example, the oxidation of iodide to the iodate ion. The exact potential required is dependent upon the concentration of the oxidisable species in solution. To accurately determine the appropriate set voltage, a cyclic voltametric sweep is automatically run and the potential set to the Ep value of the appropriate voltametric peak. (The Ep value is defined for these purposes as the potential at which the current is at its maximum current value). This methodology takes automatic account of the appearance of any over potentials that develop on the electrode.

The potentials of each of these species is pH dependent and it may be necessary to adjust the pH of the solution prior to the oxidation taking place to a value where there is a suitable separation of the potentials. For example in the case of iodine it is preferable that the solution pH be acidic (pH<4) in order to minimise the over oxidation of the iodide species eg higher oxidation state than I₂.

Many of the halogens produced form compounds with the halide ion. For example iodine and iodide form the triiodide ion. This species represents an intermediate which is soluble in the solution and which must be further oxidised to iodine before the species is allowed to reach the counter electrode. If the later takes place, the triiodide species will be re reduced back to iodide at the counter electrode. This forms a redox shuttle in the solution and electrical energy is expended with no useful quantity of product forming. There are two different methods of avoiding electroactive species reaching the counter electrode, namely the tank electrowinning cell and flow through cell.

Flow Through Cell (FIG. 1)

In this arrangement the halide solution is passed continuously through a pipe shaped electrowinning cell. The counter electrode is located upstream of the main electrode. Sufficient current is supplied to the main electrode to ensure full oxidation of all of the iodide present to iodine as it passes across the main electrode. The iodine tends to precipitate downstream of the main electrode and can be collected via a take out valve.

Tank Electrowinning Cell (FIG. 2)

In this case, a fixed quantity of halide solution is introduced into a tank reactor, the counter electrode is isolated from the main solution by means of a membrane, for example a Nafion membrane, or by a glass frit. The chamber in which the counter electrode is placed is filled with for example an acid solution such as sulphuric acid. The acid solution will tend to become less acidic during the process and may need to be replaced periodically. The halogen will form on and around the main electrode and in the case of iodine will generally precipitate to the bottom of the tank where it can be collected. Rotation of the electrode with a scraping device can be employed to assure that mass transport of the electrode is not a limiting factor and that the product does not build up in the electrode.

The main electrode itself may be of simple plate or tube design or may be constructed from materials such as a metal wool, metal coils or other high surface area forms of a conductive material including carbon and graphite.

The physical form of iodine as a material can have important effects on its properties relevant to certain applications. In particular the rate at which it dissolves is a feature of its physical morphology. As is well known to those skilled in the art of chemistry a slightly soluble substance such as iodine will dissolve to a certain extent in a solvent such as water. This extent is called the saturation point or saturation concentration. The saturation concentration is independent of the physical form of the substance as long as it is pure. The rate at which the material dissolves up to this limit may, however, depend very strongly on the physical morphology of the material. As is well known, fine powders will typically dissolve more rapidly than large pieces of the material, due to high contact surface area with the solvent. Iodine is typically produced commercially in a variety of forms. Crystalline iodide or sublimed iodine is typically a material containing quite large crystallites. In this form, the iodine vaporizes quite rapidly at room temperature. This can be a safety hazard. It also causes the iodine in a sealed vessel to ‘recrystallize” into large masses of material which can subsequently be more difficult to handle. Prilled iodine solves some of these problems since it is a pelletised material of low surface area and thereby has lower tendency to volatilise and recrystallise. However prilled iodine only dissolves in water very slowly. It is thus a still further purpose for the present invention to provide a novel form of iodine which has very high surface area and which thereby exhibits rapid solubility in water.

According to a preferred embodiment of the invention, the product of the process is an iodine specie in a molecular morphological form that is different from the known forms of iodine species produced by prior art methods. This form has particular advantages when it is desired to dissolve the iodine in water in a flowing system. The iodine produced by the process of this invention is described herein as Electro-deposited Iodine, (EDI).

The EDI is characterized as being of high surface area and of a fluffy, particulate bulk form. Its bulk density is considerably lower than normal forms of iodine. Iodine has theoretical density of 4.930 g/cm3 and typically has a packaged bulk density around 2.25 g/cm3. By bulk density is meant the apparent density of a substance obtained by observing the volume of a container that a given mass occupies. The bulk density is always lower than the real density because of packing inefficiencies of the crystallites in the container.

By comparison, typically the bulk density of EDI is 1.55 g/cm3 and it is normally lower than 2.0 g/cm3. The exact value of bulk density depends on the details of the electrowinning method applied. An iodine species with low bulk density will dissolve in solution faster than one with a higher bulk density. The origin of these properties lies in the way the iodine forms on the surface of the electrode, which is a function of the material selected for the electrode; this is a function of the electrode material and also of the current density, voltage level and supporting electrolyte. During formation of the EDI the deposits grow out from the electrode forming irregular aggregates of smaller particles of high external surface area. Eventually these particles break away from the surface, to form a loose powder having a high surface area.

At high applied potentials molecular oxygen is also formed at the electrode. This causes more rapid breaking away of the particles and thereby produces a smaller particle of different morphology. The potential is therefore useful as a variable in controlling the nature of the EDI produced.

A further property of the EDI is the rapid rate at which it will dissolve in water. For comparison, Table 1 below presents data showing the amount of iodine dissolved in a sample of 250 mls of water at room temperature after 2, 5 and 10 minutes of constant stirring. EDI is compared with sublimed and prilled iodine; these are well known species of iodine.

An excess of solid iodine is present, being 1 g in each case, such that the solution will reach saturation point with iodine remaining undissolved. The results are expressed as a % of saturation concentration. In the case of the EDI the sample has completely dissolved in three minutes whereas in the case of the prior art species, iodine saturation point is only reached after in excess of 10 minutes. Thus EDI dissolves 3 to 4 times more quickly than the prior art forms of iodine.

TABLE 1
Iodine Dissolution expressed as a % of saturated level.

| | 3 minutes | 5 minutes | 10 minutes |
|---|---|---|---|
| EDI | 100% | 100% | 100% |
| Sublimed | — | 64% | 92% |
| Prilled | — | 36% | 78% |

The operation of the process and method aspects of the invention will now be described according to specific examples;

### EXAMPLE 1

The electrowinning potential for a 100 mg/ml iodide solution on a stainless steel electrode is determined by carrying out a cyclic voltammetry run of the electrode in the solution. To do this the potential is scanned from zero volts to 2 volts at 100 mV/s while the current is measured. The cyclic voltammogram obtained appears as in FIG. 3. The trace shows a characteristic wave in current. At the top of this wave the electrowinning process is taking place. The optimal potential is chosen from this trace as the lowest potential at which the current is at or close to its maximum. In this case 1.5 V.

### EXAMPLE 2

The following example illustrates a method of obtaining electro-deposited iodine (EDI). Electro winning of iodine is accomplished using a three-electrode system. A stainless steel working (Grade 18/8) electrode comprises 3 separated 40 mm discs mounted on a spindle. The reference electrode is a commercial Ag/Ag⁺ electrode and the counter electrode is a stainless steel disc. The electrolysis cell consists of a 120 ml glass vessel with porosity 5 sinter in the base. A solution of 100 ml of 100 mgml⁻¹ potassium iodide in 0.1M H₂SO₄ is added to the electrolysis cell. A Teflon coated magnetic stirrer bead is used to stir this solution. The electrolysis cell is then placed in a large dish containing about 1 litre of 0.1M H₂SO_{4.} The anode electrode and reference electrode are then immersed in the acidic potassium iodide solution and the counter electrode placed in the outer container of dilute sulphuric acid. The electrodes are connected to a potentiostat and the voltage set to +1.5 volts. A current of about 900 mAmps flows. The solution immediately changes colour, turning brown as iodine reacts with excess iodide to form the tri-iodide species. Hydrogen gas may be observed bubbling off the cathode electrode. As electrolysis proceeds, the solution becomes even darker until all the iodide has been consumed. The colour of the solution then begins to lighten and solid iodine is observed on all the surfaces of the anode electrode. The electrolysis is continued until a steady residual current of about 40 mAmps is obtained. The potentiostat is then turned off and the anode removed and the iodine filtered, dried and weighed. 7.2 grams of iodine is obtained. This represents a 95% conversion of iodide to iodine.

### EXAMPLE 3

The same procedure is used as in Example 2 except that the glass frit used to separator is replaced with a Nafion membrane.

### EXAMPLE 4

The same procedure is used as in example 2 except that a tank type cell is used as shown diagrammatically in FIG. 2. The iodine forms in the same way and the conversion efficiency is the same.

In laboratory use of electrochemical oxidation, the overall recovery of the material is not usually of prime importance. On the other hand in a commercial process the recovery of the target material at close to 100% levels is of prime economic and environmental significance. A yet further object of the present invention is therefore to provide according to one embodiment a process by which iodine can be recovered from iodide solutions in an overall highly atom efficient manner with respect to iodide. The electrowinning process of the present invention only reaches 100% conversion of halogen after very long times of electrowinning. A residual typically 5-10% of the halide remains. This can be recovered by passing the solution from the electrowinning cell through an anion exchange resin which will selectively absorb iodide. Once the resin is fully loaded, the iodide can be stripped off and returned to the electrowinning process. The same procedure is useful when the concentration of the iodide solution is low (that is less than about 0.001 mol dm-3). Under such circumstances the electrowinning process can be disadvantageously slow. Such solution scan be first passed through anion exchange columns which absorb the halogen specie, stripped once fully loaded to capacity and then passed into the electrowinning process of this invention.

It will be recognised by persons skilled in the art that numerous variations and modifications may be made to the invention as broadly described herein without departing from the overall spirit and scope of the invention.

The claims defining the invention are as follows:

1 An apparatus for the recovery of a heavy halogen or pseudohalogens from a halide compound in solution; wherein the apparatus includes;
an electrochemical cell including, an electrode assembly including at least a first and second electrodes in communication with a controller for providing a current to at least two of said electrodes;
wherein, upon delivery of a current sufficient to generate a predetermined voltage measured between one of said first and second electrodes and a reference electrode placed in said solution in close proximity to said first electrode, said halide compound is oxidised at one or more said electrodes to form a halogen corresponding to said halide in solution whereupon said halogen is deposited on said one or more electrode; wherein gradual production of the halogen takes place at a controlled voltage close to the oxidation potential for the halide solution on an anode.

2 An apparatus according to claim 1 wherein said predetermined voltage is determined according to the concentration of said halide compound and the pH of said solution.

3 An apparatus according to claim 2 wherein said first electrode is an anode and the second electrode is a cathode; wherein all voltages are measured with respect to the reference electrode.

4 An apparatus according to claim 3 wherein said anode and said reference electrode are immersed in a solution including Iodide ions in a predetermined concentration of acid.

5 An apparatus according to claim 4 wherein said cathode is immersed in a bath of a predetermined concentration of acid separated from the halide solution by a membrane.

6 An apparatus according to claim 5 wherein the halide is iodide and the halogen is iodine.

7 An apparatus according to claim 6 wherein iodine is deposited in solid form.

8 An apparatus according to claim 7 wherein material for said anode is selected from platinum, platinum alloys, platinum plated materials or stainless steel.

9 An apparatus according to claim 8 wherein said cathode is selected from platinum, platinum alloys, platinum plated materials, stainless steel or graphite.

10 An apparatus according to claim 9 wherein, the oxidation potential for iodide is a function of the halide and electrode material chosen.

11 An apparatus according to claim 10 wherein said reference electrode is Ag/Ag+

12 An apparatus according to claim 11 wherein the oxidation potential for iodide is within the range of +1.4 to 1.6 volts when the cathode is stainless steel.

13 An apparatus according to claim 12 wherein the solution is mixed with an acid such that the pH of the mixture is less than 4.

14 An apparatus according to claim 5 wherein the cathode is immersed in a bath of H₂SO₄.

15 An apparatus according to claim 9 wherein the electric potential required for the production of iodine will fall within the range ca +0.4 to 0.5 volts for iodide on a platinum electrode.

16 An apparatus according to any of the foregoing claims wherein the halide ion is present in a moving solution.

17 A method of recovery of a heavy halogen or pseudohalogen by oxidation of a solution having a corresponding halide compound, the method comprising the steps of:
f) taking an electroreactor and placing the reactor in a tank or moving stream of liquid;
g) providing in said reactor a first electrode in communication with a controller;
h) providing at least a second electrode in communication with said controller;
i) applying a current between said first and second electrodes sufficient to generate a predetermined voltage measured between one of said electrodes and a reference electrode placed in said solution in close proximity to the said first electrode, electroreactor to oxidize said halide in solution
providing means for collecting said halogen corresponding to said halide and precipitated at one said electrode.

18 A method according to claim wherein there are three electrodes, a first comprising an anode, a second electrode comprising a cathode and a third electrode comprising The reference electrode

19 A method according to claim 18 wherein a controlled potential close to the measured oxidation potential for the predetermined halide on the working electrode is maintained between said anode and cathode and a reference electrode placed in said solution in close proximity to the said anode and cathode.

20 A method according to claim 19 comprising the further step of allowing oxidation of the halogen to take place at a controlled potential close to the measured oxidation potential for the halide on the anode.

21 A method according to claim 20 comprising the further preliminary step of determining an appropriate set voltage from an automatically run cyclic voltametric sweep and setting the potential to an Ep value of the appropriate voltametric peak; wherein the Ep value is the potential at which the current is at its maximum value.

22 A method according to claim 21 wherein said halogen is precipitated on said anode as a particulate high surface area solid.

23 A method for the electrowinning of the heavy halogens and pseudohalogens comprising the steps of;
a) taking an electroreactor including at least two electrodes;
b) delivering to said electrodes a current sufficient to generate a predetermined voltage measured between one of the said electrodes and a reference electrode placed in said solution in close proximity to a first of said at least two electrodes,
c) performing electrowinning by the controlled oxidation of the corresponding halide species at one said electrodes forming an anode;
d) collecting the halogen either as a soluble species or as a solid material; wherein production of the halogen takes place at a controlled potential close to the oxidation potential for the halide solution on the anode.

24 A method according to claim 23 wherein said at least two electrodes comprise an anode and cathode and wherein solid species is precipitated on said anode in a high surface area and fast solubility particulate form.

25 An iodine specie produced by an apparatus for the recovery of a halogen from a halide compound in solution; wherein the apparatus includes;
an electrode assembly including at least a first and second electrodes in communication with a controller for providing a current to at least one said electrodes;
wherein, upon delivery of a current sufficient to generate a predetermined voltage measured between one of the said first and second electrodes and a reference electrode placed in said solution in close proximity to the said first electrode, said halide compound is oxidised at one or more said electrodes to form a halogen corresponding to said halide in solution; whereupon said halogen is deposited in a morphological form having high surface area.

26 An iodine specie according to claim 27 wherein iodine is deposited on and collected from said one or more electrodes upon completion of oxidation; wherein said iodine specie has a bulk density less than 2.25 g/cm3.

27 An iodine specie according to claim 26 wherein the bulk density falls within the range 1.55 g/cm3-2.0 g/cm3.

28 An iodine specie according to claim 27 wherein a bulk density value is determined by a selected method of electrowinning.

29 An iodine specie according to claim 28 wherein the bulk density is a function of the manner of formation of said iodine specie on an anode employed in said apparatus for recovery of said halogen.

30 An iodine species according to claim 29 wherein the iodine deposited on said anode in said molecular or particulate morphological form having high surface area is fast dissolving relative to known iodine species.

31 An iodine specie according to claim 30 wherein said particulate morphology of said iodine deposited on said electrode is a function of a selected electrode material, current density, voltage level and a supporting electrolyte employed in said apparatus

32 An iodine specie formed by an electrowinning process, characterised in that the iodine specie produced by the process is deposited on an electrode in particulate form, having particle sizes within the range of 1 nm to 10 micrometers.

33 An iodine specie according to claim 32 characterised in that the iodine has a high surface area and is fast dissolving by comparison to known iodine species.

34 An iodine specie according to claim 33 wherein the iodine dissolves 3-4 times faster than known iodine species such as prilled or sublimed iodine.

35 An iodine specie according to claim 25 or 32 wherein a majority of particle sizes of iodine fall within the range of 100 nm-1 micro meter.

36 An iodine specie according to claim 25 or 32 wherein an electric potential required for the production of said iodine specie will fall within the range ca +0.4 to 0.5 volts for iodide on a platinum electrode and between 1.4 and 1.6 V on a stainless steel electrode.

37 An apparatus according to claim 1 wherein the controller is a potentiostat or current generator.

38 An apparatus according to claim 37 wherein the amount of current delivered by said current generator is set manually or by computer control in order to produce the required potential at said anode as measured between said anode and said reference electrode.

39 An apparatus according to claim 38 wherein there is provided an optical sensor in line such that the concentration of the iodine or other halogen in the flowing solution can be monitored by colorimetry and fed by computer control into an electrical control sequence such that the amount of current is adjusted to produce an optimum degree of oxidation.

40 An apparatus according to claim 41 wherein said reference electrode allows a reliable measurement of the potential of said anode irrespective of the current flowing in said electroreactor.

41 An apparatus according to claim 40 wherein the potential of said anode is held by said potentiostat at a potential required to oxidize a halide, but not so high as to allow other parasitic processes.

42 A method according to claims 18 or 24 wherein said cathode is immersed in a bath of a predetermined concentration of acid separated from the halide solution by a membrane.
